(19) United States
(12) Patent Application Publication
(10) Pub. No.: US 2026/0050969 A1
(43) Pub. Date: Feb. 19, 2026

(54) COMPUTER-IMPLEMENTED METHODS, SYSTEMS COMPRISING COMPUTER-READABLE MEDIA, AND ELECTRONIC DEVICES FOR PROVIDING ACCOUNT IDENTITY LARGE LANGUAGE MODEL DYNAMIC OPEN BANKING SERVICES

(71) Applicant: Mastercard International Incorporated, Purchase, NY (US)

(72) Inventors: Justin Harnish, Salt Lake City, UT (US); Brijesh Garabadu, Sandy, UT (US); Nick Baguley, Salt Lake City, UT (US); Serge Bernard, Ridgefield, CT (US)

(73) Assignee: Mastercard International Incorporated, Purchase, NY (US)

(21) Appl. No.: 18/809,114

(22) Filed: Aug. 19, 2024

(51) Int. Cl. G06Q 40/02

(52) U.S. Cl. CPC G06Q 40/02

(57) ABSTRACT

A computer-implemented method for providing dynamic LLM open banking services that includes: generating a predefined training action and a predefined prompt modification for consumer identity data prompts and storing with respective metadata configured for matching against values for performance characteristics of the LLM; generating an output based on a first prompt for consumer identity data to the LLM; evaluating the output against the predefined performance characteristics to generate values; matching the values to the predefined training action and prompt modification using the metadata; based on the predefined training action, curating a training data set and retraining the LLM thereon to generate a retrained LLM; based on the predefined prompt modification, generating a second prompt seeking consumer identity data; and generating a second output based on the second prompt to the retrained LLM.

### FIELD OF THE INVENTION

The present disclosure generally relates to computer-implemented methods, systems comprising computer-readable media, and electronic devices for dynamically and automatically moving large language model dynamic open banking services toward a system objective.

### BACKGROUND

Open banking services provide secure platforms for the aggregation, exchange and validation of financial information. The platforms often enable greater visibility for lenders into potential borrowers'financial lives to support better decisioning. They also help banks and other financial institutions interact with consumers and one another, as well provide services to and consented data sharing with entities such as credit reporting bureaus and the like.

Serving as an information intermediary between so many diverse entities gives rise to technological challenges, requiring onerous manual intervention and decision-making. For example, efficient aggregation of data balanced against timeliness requirements, as well as the inherent structure (or lack thereof) of open banking data, present barriers to efficient operation and timely service. Further, automating technological interventions and decision-making is difficult or impossible to achieve in a consolidated, dynamic manner with existing technologies. Namely, artificial intelligence (AI) solutions are not adapted for such open banking uses.

This background discussion is intended to provide information related to the present invention which is not necessarily prior art.

### BRIEF SUMMARY

Embodiments of the present technology relate to computer-implemented methods, systems comprising computer-readable media, and electronic devices for providing dynamic large language model (LLM) open banking services. The embodiments provide a technological mechanism for consolidated, dynamic provision of such services. Namely, embodiments of the present invention automatically adapt LLMs to open banking system objectives and data-rich vernacular, providing a production tool for meeting and improving on achievement of such objectives.

More particularly, in an aspect, a computer-implemented method for providing dynamic large language model (LLM) open banking services may be provided. The method may include: generating a predefined training action and a predefined prompt modification for consumer identity data prompts and storing with respective metadata configured for matching against values for performance characteristics of the LLM; generating an output based on a first prompt for consumer identity data to the LLM; evaluating the output against the predefined performance characteristics to generate values; matching the values to the predefined training action and prompt modification using the metadata; based on the predefined training action, curating a training data set and retraining the LLM thereon to generate a retrained LLM; based on the predefined prompt modification, generating a second prompt seeking consumer identity data; and generating a second output based on the second prompt to the retrained LLM. The method may include additional, less, or alternate actions, including those discussed elsewhere herein.

In another aspect, non-transitory computer-readable storage media having computer-executable instructions stored thereon for providing dynamic large language model (LLM) open banking services may be provided. When executed by at least one processor the computer-executable instructions cause the at least one processor to: generate a predefined training action and a predefined prompt modification for consumer identity data prompts and store with respective metadata configured for matching against values for performance characteristics of the LLM; generate an output based on a first prompt for consumer identity data to the LLM; evaluate the output against the predefined performance characteristics to generate values; match the values to the predefined training action and prompt modification using the metadata; based on the predefined training action, curate a training data set and retrain the LLM thereon to generate a retrained LLM; based on the predefined prompt modification, generate a second prompt seeking consumer identity data; and generate a second output based on the second prompt to the retrained LLM. The instructions, when executed, may cause the at least one processor to perform additional, less, or alternate actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various components, in block schematic form, of an exemplary system for providing dynamic large language model (LLM) open banking services in accordance with embodiments of the present invention;

FIGS. 2, 3 and 4 illustrate various components of exemplary computing devices shown in block schematic form that may be used with the system of FIG. 1;

FIG. 5 is a flowchart of exemplary systems and components thereof for providing dynamic LLM open banking services, in accordance with embodiments of the present invention;

FIG. 6 is a flowchart of exemplary systems and components thereof for dynamically and automatically moving LLM dynamic open banking services toward a system objective, in accordance with embodiments of the present invention;

FIG. 7 illustrates at least a portion of the steps of an exemplary computer-implemented method for providing dynamic LLM open banking services in accordance with embodiments of the present invention; and

FIG. 8 illustrates at least a portion of the steps of an exemplary computer-implemented method for providing dynamic LLM open banking services in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Existing methods for providing open banking services are heavily manual and often incorporate a patchwork of disparate technological tools. Further, adjusting such methods to accommodate new data encountered in the unique open banking environment requires extensive and time-consuming manual efforts.

A more efficient, consolidated and dynamic method for providing open banking services is needed.

According to embodiments of the present invention, a technological mechanism is provided for improved open banking services via a dynamic large language model (LLM). Namely, embodiments of the present invention automatically take steps to manage and/or provide such services while, in parallel, automatically evolving to overcome technological challenges arising out of implementation within unique conversations reliant on open banking data and vernacular.

### Exemplary System

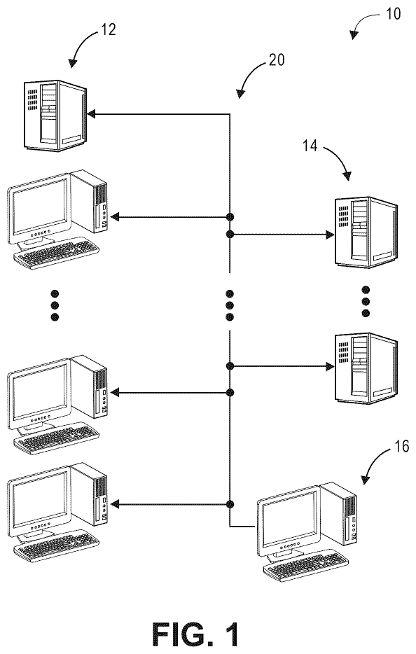

FIG. 1 depicts an exemplary environment 10 for providing LLM open banking services by dynamically and automatically moving the services toward a system objective, according to embodiments of the present invention. The environment may include a plurality of client devices 12, a plurality of servers 14, a service device 16, and a communication network 20. Client devices 12, servers 14 and the service device 16 may be located within network boundaries of an organization, such as a corporation or the like that provides open banking services. One or more client devices 12 and servers 14 may also be outside the network boundaries of the organization.

The communication network 20 may be partly or even mostly internal to the organization, for example where the servers 14 manage databases of and/or provide cloud-based services to and under the management of the organization, and a client device 12 is also under the management of the organization. Also or alternatively, the client devices 12, servers 14 and service device 16 may access each other via transmissions, at least in part, across public/semi-public telecommunication network infrastructure, with the communication network 20 being at least in part comprised of such public/semi-public telecommunication network infrastructure.

All or some of the client devices 12, servers 14, service device 16 and/or all or some of the virtual resources managed thereby, may at least partly comprise a secure network computing environment. Alternatively or in addition, the service device 16 may manage access and transmissions between and among itself and the client devices 12 and servers 14 under an authentication management framework. For example, each user of a client device 12 may be required to complete an authentication process to access secure data provided via the servers 14 and/or the services provided by service device 16. In one or more embodiments, any authentication management framework may be utilized including, without limitation, custom frameworks.

For example, the service device 16 may host, aggregate and analyze data and host and provide access to/use of applications comprising open banking services. In one or more embodiments, the open banking services comprise data aggregation, analysis, management and data sharing services whereby consumers and businesses may subscribe for consented and controlled sharing of data with financial service providers and/or institutions.

Data subjects (e.g., consumers and businesses seeking financial services from financial service providers) may subscribe for the open banking services, and identify one or more financial accounts or data/documents sources from which to share data and/or directly provide copies of financial and identification information (e.g., access credentials) and documents. The data subjects may also consent to controlled sharing of such financial, identity- and/or location-related information with the open banking services of the service device 16 and, in turn, with consented data recipients (e.g., the financial service providers).

In turn, data recipients (e.g., lenders, credit score agencies, credit card service providers, or other financial institutions or financial service providers) may subscribe and access the open banking services and subject data, for example to calculate credit scores, open new financial accounts, provide advice about improving credit scores, approve loan requests from data subjects, and perform other financial services.

The consented data provided with the permission of data subjects may be provided directly (e.g., via upload from client devices 12) and/or by directive of the data subjects given to the service device 16 and/or one or more servers 14. For example, a data subject may provide access credentials used to access server(s) 14 which host financial institution or service provider application programming interfaces (APIs), with such APIs providing access to the data subject's financial account records. The data subject may thereby direct the server 14, whether directly or indirectly, to provide the service device 16 with all or some such financial account records, and may establish conditions and parameters around such sharing and/or around subsequent sharing by the service device 16 with data recipients (e.g., financial service providers also subscribed to the open banking services). Consenting to and retrieval of data subject data may take a variety of forms, and utilize a variety of data sources having a variety of formats, within the scope of the present invention.

Accordingly, data subjects and data recipients may subscribe for the open banking services, for example through the use of and access provided by service device 16. The open banking services may be provided by the service device 16 to the client devices 12 and/or servers 14. It should again be noted that the service provider or organization providing the open banking services may itself include client devices 12 and service devices 16, for example where the dynamic LLM of embodiments of the present invention is queried by users of the service provider organization. Topics of such queries may include optimization of the open banking services (e.g., of aggregation operations), as discussed in more detail below. The open banking service provider may also or alternatively include servers 14, for example where the service provider has consented access to credit card transaction records and data of the data subjects and/or which may be accessed to enhance analyses and data enrichment services performed by the open banking service provider.

One of ordinary skill will appreciate that embodiments may serve a wide variety of individuals and organizations and/or rely on a wide variety of data sources (and formats) and/or service providers within the scope of the present invention. It should also be noted that reference herein to a “business organization,” “corporation” or the like are made for ease of reference, and that embodiments of the present invention are equally applicable to individual users and/or partnerships subscribing to and/or providing open banking services.

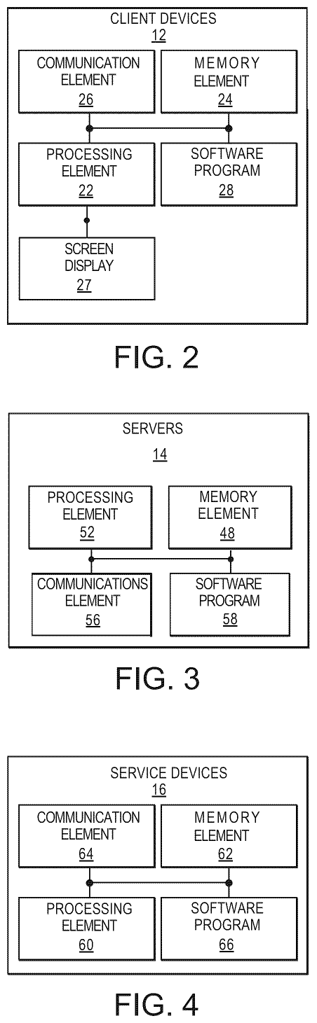

Turning to FIGS. 2 and 4, generally the client devices 12 and the service devices 16 may include tablet computers, laptop computers, desktop computers, workstation computers, smart phones, smart watches, and the like. In one or more embodiments, the client devices 12 and/or the service devices 16 may comprise server(s), examples of which are discussed in more detail below.

Client devices 12 and service device(s) 16 may each respectively include a processing element 22, 60, a memory element 24, 62, and circuitry capable of wired and/or wireless communication with the communication network 20, including, for example, a transceiver or communication element 26, 64. Each of the client devices 12 may additionally include a screen display 27, which may comprise a user interface of the client device 12. The display 27 may include video devices of any of the following types: plasma, standard or ultra-high-definition light-emitting diode (LED), organic LED (OLED), quantum dot LED (QLED), Light Emitting Polymer (LEP) or Polymer LED (PLED), liquid crystal display (LCD), thin film transistor (TFT) LCD, LED side-lit or back-lit LCD, or the like, or combinations thereof. The display 27 may possess a square or a rectangular aspect ratio and may be viewed in either a landscape or a portrait mode. In various embodiments, the display 27 may also include a touch screen occupying all or part of the screen.

Further, each of the client devices 12 and the service device 16 may include a software application or program 28, 66 configured with instructions for performing and/or enabling performance of at least some of the steps set forth herein. In an embodiment, the software programs 28, 66 each comprises instructions respectively stored on computer-readable media of a memory element 24, 62.

The servers 14 generally receive requests and/or consents for data sharing from the client devices 12—directly or indirectly via the service device 16—and expose or otherwise provide such subject data and other data to the service device 16 for intake, aggregation, analysis and consented sharing managed by the service device 16. In one or more embodiments, a service device 16 enrolls all or some of the client devices 12 and servers 14 and/or the resources embodied thereby for receipt of and/or participation in the open banking services.

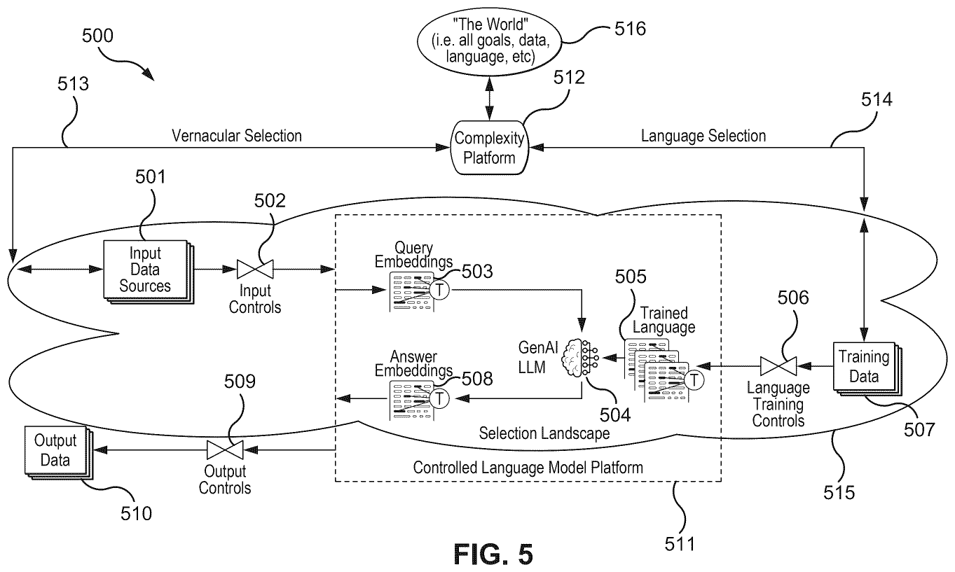

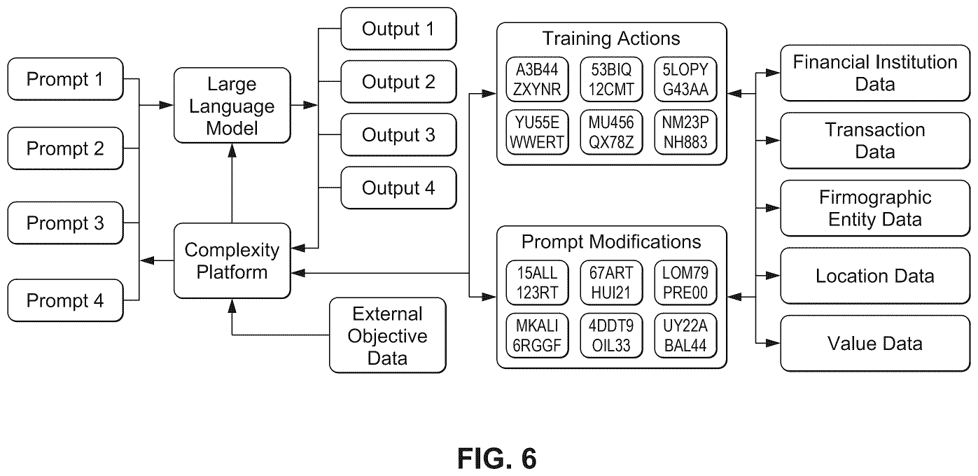

The servers 14 may comprise cloud servers, domain controllers, application servers, database servers, database web servers, file servers, mail servers, catalog servers or the like, or combinations thereof. In one or more embodiments, one or more data sources (see FIGS. 5 and 6) may be maintained by one or more of the servers 14. Generally, each server 14 may include a memory element 48, a processing element 52, a communication element 56, and a software program 58.

The communication network 20 generally allows communication between the client devices 12, the servers 14, and the service device 16, for example in conjunction with device enrollment, data acquisition, data consenting, data aggregation, data analysis and data sharing with recipient devices in connection with open banking services provided by the service device 16.

The communication network 20 may include the Internet, cellular communication networks, local area networks, metro area networks, wide area networks, cloud networks, plain old telephone service (POTS) networks, and the like, or combinations thereof. The communication network 20 may be wired, wireless, or combinations thereof and may include components such as modems, gateways, switches, routers, hubs, access points, repeaters, towers, and the like. The client devices 12, servers 14 and/or services device(s) 16 may, for example, connect to the communication network 20 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication elements 26, 56, 64 generally allow communication between the client devices 12, the servers 14, the service device 16 and/or the communication network 20. The communication elements 26, 56, 64 may include signal or data transmitting and receiving circuits, such as antennas, amplifiers, filters, mixers, oscillators, digital signal processors (DSPs), and the like. The communication elements 26, 56, 64 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the communication elements 26, 56, 64 may utilize communication standards such as ANT, ANT+, Bluetooth™ low energy (BLE), the industrial, scientific, and medical (ISM) band at 2.4 gigahertz (GHz), or the like. Alternatively, or in addition, the communication elements 26, 56, 64 may establish communication through connectors or couplers that receive metal conductor wires or cables, like Cat 6 or coax cable, which are compatible with networking technologies such as ethernet. In certain embodiments, the communication elements 26, 56, 64 may also couple with optical fiber cables. The communication elements 26, 56, 64 may respectively be in communication with the processing elements 22, 52, 60 and/or the memory elements 24, 48, 62.

The memory elements 24, 48, 62 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 24, 48, 62 may be embedded in, or packaged in the same package as, the processing elements 22, 52, 60. The memory elements 24, 48, 62 may include, or may constitute, a “computer-readable medium.” The memory elements 24, 48, 62 may store the instructions, code, code segments, software, firmware, programs, applications, apps, services, daemons, or the like that are executed by the processing elements 22, 52, 60. In an embodiment, the memory elements 24, 48, 62 respectively store the software applications/programs 28, 58, 66. The memory elements 24, 48, 62 may also store settings, data, documents, sound files, photographs, movies, images, databases, and the like.

The processing elements 22, 52, 60 may include electronic hardware components such as processors. The processing elements 22, 52, 60 may include digital processing unit(s). The processing elements 22, 52, 60 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 22, 52, 60 may generally execute, process, or run instructions, code, code segments, software, firmware, programs, applications, apps, processes, services, daemons, or the like. For instance, the processing elements 22, 52, 60 may respectively execute the software applications/programs 28, 58, 66. The processing elements 22, 52, 60 may also include hardware components such as finite-state machines, sequential and combinational logic, and other electronic circuits that can perform the functions necessary for the operation of embodiments of the current invention. The processing elements 22, 52, 60 may be in communication with the other electronic components through serial or parallel links that include universal busses, address busses, data busses, control lines, and the like.

Data queries or requests for services may be initiated via user applications embodied, controlled and/or executed by client devices 12, servers 14 and/or service device(s) 16. In an embodiment, access to user applications, client devices 12, servers 14 and/or service device(s) 16 is granted via one or more authentication framework(s) such as those outlined above, for example where account identification and consents are provided by one or both of the open banking service platform and the platform(s) of financial institution(s) at which data subjects hold accounts.

Data sources hosted by the servers 14 may utilize a variety of formats and structures within the scope of the invention. For instance, relational databases and/or object-oriented databases may embody the data sources, and may be exposed for queries by one or more corresponding APIs. One of ordinary skill will appreciate that—while examples presented herein may discuss specific types of operating systems and/or databases—a wide variety may be used alone or in combination within the scope of the present invention.

In one or more embodiments, the software program 58 of one or more of the servers 14 may translate data from the authentication management framework and/or from the client device(s) 12 into identity information for use in connection with authenticating individuals or end users (i.e., data subjects or consented data recipients) for access to data and services by the service device 16 and data recipients. One of ordinary skill will appreciate that a variety of user or data subject information—including, without limitation, credentials and/or biometric or device data—may comprise and/or be used to generate the identity information within the scope of the present invention. It is foreseen that the program 58 may function in connection with a variety of authentication frameworks without departing from the spirit of the present invention.

The program 58 may be configured with policies that define limits to data access, for example with respect to data volume and/or frequency/timing of access events, by the service device 16. In one or more embodiments, these may include financial institution (FI) rate limits. The program 58 may permit service device 16 and/or a service provider employee of the open banking service to have limited access to those aspects and data entries/records which are consented by the corresponding data subject (and, optionally, the financial institution(s)), including under the authentication management framework.

One of ordinary skill will appreciate that the software program 28 of one or more of the client devices 12 may similarly manage access by the service device 16 to aspects of the client devices 12 and/or data stored thereby, particularly where such aspects form a part of or relate to the consented data of the data subject. In one or more embodiments, the service device 16 negotiates such limits (e.g., imposed by financial institutions operating the server(s) 14 and/or by client device 12) by prioritizing data access and aggregation for open banking services which require more frequent access, are in more demand, or otherwise to optimize and balance business objectives of the open banking service provider. Additional detailed discussion regarding such limits is included below.

In one or more embodiments, the service device 16 implements an open banking service for client devices 12 controlled by data recipient subscribers. The data recipient subscribers, for example, may calculate credit scores, open new financial accounts, provide advice about improving credit scores, approve loan requests and otherwise perform financial-related tasks for data subjects.

In one or more embodiments, performance of the open banking services includes the service device 16 processing queries from one or more of the devices 12, 14 about, to support and/or as a part of the open banking services. The corresponding exchanges are unique conversations that present technological challenges arising out of the uniqueness of the open banking data and vernacular present in each.

Embodiments of the present invention include a dynamic LLM participating in each such conversation. More particularly, the service device 16 may include or implement computer-implemented methods, systems comprising computer-readable media, and electronic devices to dynamically and automatically move an LLM toward system open banking objectives, enabling and improving the service device's 16 capability to engage meaningfully in such a conversation and provide the open banking services.

For example, the open banking service may improve intake, aggregation and analysis of data provided to the platform by using a dynamic LLM to identify transactional entities in unstructured data (e.g., in memo and description fields in open banking transaction data) and to associate representations and descriptions of those entities with a standardized identity. Such services of the dynamic LLM may also/alternatively include identifying geographic location(s) for entities, categorizing entities into product/service/industry types, and/or categorizing or generating explanations for financial transactions (e.g., purposes of or reasons for the transactions). In one or more embodiments, these analyses and identifications/categorizations may be considered enrichment of the subject data by service device 16, which supports or comprises the open banking services.

For another example, open banking data intake, aggregation and analysis may be improved by querying a dynamic LLM for recommendations about how best to balance open banking service objectives and data source (i.e., FI) restrictions and limitations (e.g., data volume and frequency or rate limits discussed above) to optimize the open banking services.

For yet another example, a dynamic LLM may be used to analyze financial data to identify individuals (e.g., data subjects) within unstructured and structured data, and verify or authenticate the individuals to a trusted or unique identity. In one or more embodiments, this includes using the dynamic LLM to sift through open banking data (e.g., unstructured or structured transaction data) and confidently associate individual identifiers and circumstantial identity information and activities associated with a request for financial services with the trusted identity and/or other known financial records, thereby generating a firm link between the requester of the financial services and the trusted identity and/or known financial records. In turn, financial data confidently associated with a trusted identity and/or known financial records may be analyzed and used to profile an individual data subject, assess credit risk, establish account ownership (and identity), or otherwise validate or authenticate the requester and the requester's behavior(s) to enable provision of the requested financial services and/or to prevent fraud. Such activities and the request for financial services may, without limitation, include a request to open a financial account with a financial institution.

For still yet another example, data subjects or recipients may assess or inquire about how best to plan/conduct financial transactions or activities in view of a broader, measurable objective. In one or more embodiments, the open banking services may include recognition and analysis of value store data, enabling measurement of progress toward objectives such as optimizing participation or investment in crypto currency ecosystems, the balance among and between triple bottom line metrics (social, environmental and economic), the balance among and between ESG metrics (environmental, social and governance) and/or a total score therefore, carbon credits or offsets, and the like.

In one or more embodiments, the program 66 is configured to implement dynamic LLMs to conduct such conversations, and to automatically improve LLM output relative to system objectives embodying features or performance characteristics of the tasks outlined above. The program 66 may iteratively modify prompts engineered to properly activate and provide context for the relationships embodied by the LLM. The prompts may include open banking data for single- or multi-shot prompting. The LLM may process each prompt and generate an output, which may be measured by the program 66 against the system objective(s).

Based on a difference between the output and the objective(s), the LLM may automatically identify a predefined training action and a predefined prompt modification. The predefined training action and prompt modification may be identified based at least in part on previous learning within or outside of the conversation at issue. For example, where the program 66 previously encountered a difference of the type and/or extent observed in the present iteration, and successfully produced movement toward a system objective by implementing a particular predefined training action and prompt modification, or a similar predefined training action and prompt, the program 66 may be configured to automatically identify and select same for a present adjustment to the LLM and/or future prompts.

In turn, the program 66 may be configured to automatically gather and generate prompting data and training data according to and to otherwise implement the identified predefined training action and prompt modification. The program 66 may further be configured to execute the identified predefined training action to retrain the LLM, and to implement the predefined prompt modification to generate one or more additional prompts. The additional prompt(s) may be fed to the retrained LLM, generating corresponding additional outputs which may be measured against the system objective(s), beginning new iterations of the automated movement toward the system objective(s).

Example systems for implementing embodiments of the present invention are illustrated in FIGS. 5-6. Turning first to FIG. 5, an LLM platform 500 is illustrated for dynamically and automatically providing open banking services and moving the services toward respective system objectives. The LLM platform 500 includes input data sources 501, input controls 502, query embeddings 503, LLM 504, trained language 505, language training controls 506, training data 507, answer embeddings 508, output controls 509, output data 510, controlled language model platform 511, complexity platform 512, vernacular selection 513, language selection 514, selection landscape 515, and world objectives data 516.

It should be noted that each of query embeddings 503, trained language 505, and answer embeddings 508 are encoded and tokenized versions of textual information respectively input to or output from the LLM. Encoding/decoding and tokenization enabling translation of human to machine language interpretable by the LLM may be performed generally in accordance with known LLM practices.

Broadly, the controlled language platform 511 encompasses those components of platform 500 that are within or surrounded by input controls 502, language training controls 506 and output controls 509. In one or more embodiments, these control components search the data intended to be input to or output from the LLM 504—whether as query embeddings 503, trained language 505, or answer embeddings 508, or unencoded upstream/downstream textual versions thereof—to identify PII and other sensitive or confidential information. For example, the controls 502, 506, 509 may use lookup tables, pattern matching or other technologies to locate and identify PII and sensitive and/or confidential information, and redact, anonymize and/or replace same (e.g., with nonce symbols, pseudonyms, or keys or tokens).

Wherever anonymous or pseudonymous keys or tokens are optionally used to retrievably obscure such PII and sensitive and/or confidential information in data input into the LLM 504, output controls 509 or other downstream components may be configured to access a table relating the keys or tokens to the original data and to replace the keys or tokens with the original data in the output data 510 (i.e., once delivered to a local, controlled and/or secure environment). However, in one or more embodiments, the PII and sensitive and/or confidential information may not be reinserted into the output data 510. It should also be noted that, in one or more embodiments, PII may be replaced by anonymous and generic monikers—such as “individual name” or “address” or other terms identifying generic categories for the removed PII—which may aid in processing corresponding queries or output analyses without revealing individual PII.

The controls 502, 506, 509 may, accordingly, prevent or restrict passage of the PII and sensitive and/or confidential information outside of the open banking service organization and/or its data sources, for example where the controlled language model platform 511, including LLM 504, are hosted outside the organization's authentication management framework (e.g., in a cloud computing environment). This may increase flexibility for the organization in adopting and implementing LLM technologies.

Controls for PII discussed herein support the information security of data entering and exiting the conversations occurring hereunder in the open banking service context. Security sufficiency may be determined through a dynamic rating along several components, and according to one or more standard(s). For example, such standard(s) may require that there never be a loss of data outside of an internal controlled computing environment and that no data used within the corresponding LLM model(s) is ever used to for training outside of the controlled computing environment. Components and standards may, for example, be established and performance evaluated along several classifications including: Access Controls; Security Compliance; Confidentiality Compliance; Documentation & Support; Data Retention; Hallucination Controls; Explainability; IP/Copyright infringement; Amplified Bias; and/or Regional Regulation.

Further, the selection landscape 515 boundary encompasses those components of the platform 500 that are or may be iteratively changed and improved as directed by the complexity platform 512. For example, the complexity platform 512 may be configured to change operation of any of components 501-508 based on determined difference(s) between one or more output(s) 510 and the system objective(s). In one or more embodiments, such changes are made in automatically identified and predefined ways, to move the LLM closer to the system objective(s), as discussed in more detail below.

In one or more embodiments, each of the components 501-516 comprises and/or is hosted by or accessible to a service device 16 for implementation in providing the open banking services. However, in one or more embodiments, the controlled language model platform 511 and its components may also or alternatively be hosted outside of the service provider organization and/or service device 16, for example where the LLM 504 is hosted in a cloud computing environment (e.g., on server(s) constructed in accordance with servers 14 discussed herein). Similarly, the data sources 501, training data 507, and objective data 516 may also or alternatively derive from or reside in external systems or devices, including without limitation in client device(s) 12 and/or server(s) 14. One of ordinary skill will appreciate that responsibility for all or some of such components may be distributed differently among such devices or other computing devices without departing from the spirit of the present invention.

Input data sources 501 and training data 507 may respectively obtain the data from data subjects, financial institutions or service providers, or other sources. The input data sources 501 and training data 507 may comprise open banking data, financial institution (FI) data regarding data subjects and/or FI terms and rate limits, account records, transaction and credit card data, firmographic entity data, location data, value data, regulatory data, personally identifiable information (PII), entity identification and/or authentication data, and/or other financial and relevant data. It should also be noted that the input data sources may comprise textual data, audio recordings and/or data and/or image data (e.g., images, videos, emojis, unstructured text, labeled/structured text, and the like) within the scope of the present invention.

Turning now to FIG. 6, a subset of logical components of an embodiment of LLM platform 500 are illustrated, along with information flows therebetween for dynamically and automatically providing open banking services and moving the services toward respective system objectives. In one or more embodiments, and in relation to the components of FIG. 5, the prompts 1-4 are fed by input data sources 501, the complexity platform is an example of complexity platform 512, the large language model is likewise an example of the LLM 504, the outputs 1-4 comprise output data 510, the external objective data comprises objective data 516, and the data stores (financial institution, transaction, firmographic entity, location and value data) feed the input data sources 501 and the training data 507. The complexity platform automatically selects from available predefined training actions and prompt modifications as the LLM iterates through the prompts and corresponding outputs to move closer to system objectives, as discussed in more detail below.

In one or more embodiments, the LLM is initially a licensed model such as those made available under the trademarks GPT-4® or CHATGPT® (registered trademarks of OpenAI OpCo, LLC) as of the date of the initial filing of the present disclosure. As discussed above, the LLM may be hosted in a cloud computing environment, locally on one or more service devices, or otherwise within the scope of the present invention. The generalized training or pretraining of the LLM—in the state received under a license, for example—may be conducted on a wide variety of data, according to known practices associated with commercially available models such as those listed above.

A preliminary step according to embodiments of the present invention may include selecting an LLM trained on language expected to be predominantly encountered in prompts and fine-tuning data corresponding to system objectives and/or the open banking service and/or region in which the open banking service will predominantly be provided. For example, the LLM may be trained on English, French, Spanish, German, Mandarin, Cantonese, Arabic, Hindi or other languages, and may be more particularly trained on data filtered for region or ethnicity (e.g., American English or British English), financial channel and/or other differences. Because the LLM will mostly encounter and output language unique to conversations reliant on particularized open banking data and vernacular, it is also foreseen that additional filters—such as for language used in economic, financial and transactional contexts—may additionally be applied to select LLMs trained on particularly relevant language within the scope of the present invention.

Further, fine-tuning of the LLM may be initially performed (e.g., before being placed in a production environment for open banking services) in view of the open banking service and system objective(s) for which it is to be used. In one or more embodiments, fine-tuning includes one or more of self-supervised, supervised and/or reinforcement learning. As discussed in more detail above, the fine-tuning may be performed with data types including open banking data such as memo or description fields of open banking records, FI data regarding data subjects and/or FI terms and rate limits, transaction and credit card data, account data, firmographic entity data, location data, value data, regulatory data, PII, entity identification and/or authentication data, and/or other financial and relevant data, and combinations thereof.

Similarly, the initially fine-tuned LLM may be tested with one or more prompts, preferably engineered according to one or more predefined strategies, to determine capabilities, efficiency and accuracy with reference to the open banking service and system objective(s) for which it is to be used. Where open banking data is submitted with the test prompts, it likewise may originate with or include memo or description fields of open banking records, FI data regarding data subjects and/or FI terms and rate limits, transaction and credit card data, account data, firmographic entity data, location data, value data, regulatory data, PII, entity identification and/or authentication data, and/or other financial and relevant data, and combinations thereof.

As discussed in more detail below, iterative fine-tuning or training steps and changes and improvements to LLM prompts are also or alternatively undertaken in or following use in a production environment, based on differences between production environment outputs and system objectives, to dynamically and automatically provide open banking services and move the services toward the system objectives.

The predefined training actions and predefined prompt modifications are preferably defined for a variety of system objectives and/or metrics relating thereto, a variety of differences between outputs and those objectives, and combinations thereof, and prescribe different types of training data, prompt modifications, and related parameters and combinations thereof.

Moreover, predefined training actions and predefined prompt modifications may be generated, defined, identified and/or selected by the complexity platform based on a batch of outputs (in contrast with or addition to implementation in response to each output individually). For example, an open banking service comprising merchant entity identification, standardization and categorization may provide a plurality of prompts and corresponding outputs from the LLM over a period of time (e.g., two (2) weeks). The complexity platform may analyze the outputs generated by the LLM over the period as a batch, including by identifying aspects of each prompt for which output was generated (e.g., what kind of data was included in the prompt, how old was the data, etc.), and classifying the performance of the LLM and quality of the outputs across multiple measurable quality metrics or indicators of the system objectives (e.g., how accurate was the entity identification, standardization and categorization, how efficient was the processing, etc.). The complexity platform may, based on the analysis, determine patterns for how well the LLM performed across multiple metrics or characteristics relating to the system objective(s) in view of the aspects of the prompts, the state of training of the LLM (e.g., data/training regimens used previously to train it), and other factors influencing or potentially influencing the performance of the LLM for the specific open banking service rendered.

Accordingly, a plurality of predefined training actions and predefined prompt modifications are stored and available to the complexity platform for selection and implementation. The plurality of training actions and prompt modifications illustrated in FIG. 6 are thus labeled according to the unique patterns or trait/performance combinations the complexity platform has previously determined each respective one is effective for improving. For example, where the analysis of output(s) relative to system objectives takes into account factors or metrics of performance, patterns gleaned from analysis, or some combination of these, each may be represented in a distinct or separate category or characteristic stored (e.g., as metadata) with the plurality of predefined training actions and predefined prompt modifications.

In the illustrated example, each training action and prompt modification is defined across ten (10) separate categories (represented in FIG. 6 as metadata comprising ten (10) alphanumeric characters on the face of each respective predefined training action and prompt modification). In one or more embodiments, the metadata and characteristic/category information is automatically generated by the complexity algorithm for efficient comparison among and retrieval of the training actions and prompt modifications for implementation to dynamically improve the LLM. More particularly, the categories or characteristics of the metadata may be referenced by the complexity platform when selecting or identifying training actions and prompt modifications to move the outputs and LLM toward the system objective(s) iteratively.

For example, the complexity platform may determine that newer transaction data has correlated to better LLM performance for certain query/output types (the first predefined category or performance characteristic), that the LLM performed better when previously trained predominantly on highly filtered and specialized datasets for certain query/output types (the second predefined category or performance characteristic), that the LLM performed better in identifying entities whose names are abbreviated in certain ways but not other ways for certain query/output types (the third predefined category or performance characteristic), and so on and so forth.

In the example of FIG. 6, the unique combination of values across ten (10) predefined categories or performance characteristics determined by the complexity platform based on analysis of the output(s) may be used to identify the corresponding predefined training action and prompt modification which are expected to best move the outputs and LLM toward the system objective(s). Again, the expectation of success may be based, for example, on the performance of previous implementations of the training actions and prompt modifications (or similar training actions and prompt modifications) when aimed at similar improvements and/or objective(s) under similar circumstances and/or on other pattern learning and/or correlation processes.

It should also be noted that, in one or more embodiments, the predefined categories or performance characteristics and other metadata used for selection of a predefined training action may take into account other details of their generation. For example, a predefined training action may be labeled with metadata indicating it is good at improving LLM performance where a certain type of value is encountered when evaluating an output against a system objective, but any conclusion regarding its efficacy may also be limited based on the prompts or prompt modifications present when the improvement was observed. The same can be said in reverse—a predefined prompt modification may be presumed effective (according to the characteristic metadata) for use in response to certain output values particularly or only when used in tandem with one or more types of predefined training actions.

In other words, a predefined training action may be more or less effective for moving the outputs and LLM toward the system objective(s) dependent on which prompt modification(s) are implemented therewith. Likewise, and for similar reasons, one or more of the predefined categories or characteristics (i.e., metadata) used for selection of a predefined prompt modification may depend at least in part on the training action(s) used in parallel therewith.

The complexity platform may therefore store relationships between different combinations of predefined training actions and prompt modifications as part of the matching metadata used to identify same for implementation in response to calculated values from evaluating output using system objectives and objective functions.

Advantageously, embodiments of the present invention implement iterative and parallel improvement of the LLM relative to given system objective(s) through automatically implemented prompt modification and fine-tuning efforts, including by learning relationships between predefined prompt modifications and fine-tuning or training data.

It should also be noted that system objective(s) may be modified or updated according to the content of prompts from users. For example, where user prompts increasing ask for additional or different datums within a given conversation—e.g., where merchant entity locations are more frequently requested in prompts in a merchant entity data conversation—the complexity platform may automatically add or revise system objective(s) and identify, generate and/or implement corresponding objective function metrics for evaluating same.

The complexity platform may comprise prompt engineering heuristics and non-linear, recursive, and super literal genetic algorithms. One of ordinary skill will appreciate, however, that other decisioning and objective function evaluation algorithms and techniques are within the scope of the present invention.

The external objective data may also permit the complexity platform to automatically adjust or evolve the system objectives themselves based on events or data originating outside the platform. In one or more embodiments, a system objective may itself reference or be dependent on external objective data accessed or aggregated continually or periodically to update the objective. For example, the system objective may be to accurately identify an entity in open banking data and match same to a standardized entity included in a standardized entity database. The standardized entity database may be external objective data accessed periodically or continuously to evaluate the outputs against the system objective(s).

Also or alternatively, analysis of such external objective data may cause the complexity platform to automatically revise the system objective(s). For example, the system objective may be to provide recommendations to a client device regarding transactions or other financial events that increase an ESG score of the entity associated with the client device. The LLM outputs may be evaluated against a first measure for determining an ESG score to determine a difference value which, in turn, can guide selection of predefined training actions and prompt modifications for moving the LLM toward better performance. However, external objective data may reflect changes to the first measure for determining the ESG score. The complexity platform may accordingly access or build a new, second metric for determining the ESG score under the revised standard and based on the external objective data, thereby revising the system objective itself based on the external objective data.

Examples of external objective data provided herein are non-limiting, it being understood that a wide variety of system objective(s), and correspondingly a wide variety of external objective data accessible for evaluating those objectives against outputs and/or automatically revising those objectives, are within the scope of the present invention.

Through hardware, software, firmware, or various combinations thereof, the processing elements 22, 52, 60 may—alone or in combination with other processing elements—be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled, unless otherwise expressly stated and/or readily apparent to those skilled in the art from the description.

### Exemplary Computer-Implemented Method for Providing Large Language Model Dynamic Open Banking Services

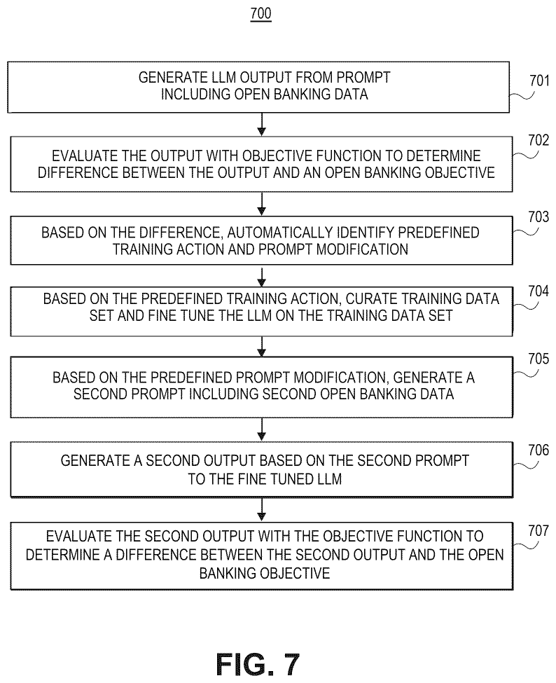

FIG. 7 depicts a flowchart including a listing of steps of an exemplary computer-implemented method 700 for providing LLM dynamic open banking services. The steps may be performed in the order shown in FIG. 7, or they may be performed in a different order. Furthermore, some steps may be performed concurrently as opposed to sequentially. In addition, some steps may be optional.

The computer-implemented method 700 is described below, for ease of reference, as being executed by exemplary devices and components introduced with the embodiments illustrated in FIGS. 1-6. For example, the steps of the computer-implemented method 700 may be performed by the client devices 12, the servers 14, the service device 16 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 701, a large language model (LLM) output may be generated from a prompt that includes open banking data. In one or more embodiments, the LLM corresponds to an LLM 504 (FIG. 5) which may be hosted in a local environment (e.g., on a service device 16) and/or in a remote (e.g., cloud computing) environment. The LLM may be preliminarily fine-tuned for participation in one or more conversations associated with provision of open banking services. For example, the LLM may be fine-tuned for conversations in the vernacular of any one or more of the following: identify a financial transaction type, identify a financial transaction entity, identify a financial transaction location, identify a financial transaction entity category, calculate a fraud risk based on financial entity identity or account ownership, optimize an open banking data aggregation process, or plan a financial event to optimize a value.

As noted in preceding sections, preliminary fine-tuning may acclimate the LLM to one or more languages encountered in the prompt(s), and/or to unique data formats, syntaxes and contents encountered within the open banking conversation for which it is configured.

The prompt may be configured and engineered to optimize the quality of the output. For example, the prompt may include a significant number of relevant examples relevant to the query it embodies (e.g., for single shot or multi-shot learning), and may include a plurality of financial account records or other data types, in each case to provide context to activate the LLM toward the most likely relevant learned relationships it embodies.

The prompt may additionally be filtered through one or more input controls (e.g., input controls 502 of FIG. 5), for example in the manner discussed in preceding sections, for identification and redaction or anonymization of personally identifiable information (PII). The removal and/or replacement of PII may occur prior to, for example, transmission to the LLM hosted in a cloud computing environment. In one or more embodiments, a draft prompt is analyzed for PII, and identified PII is automatically redacted or anonymized to generate the prompt. As noted above, the PII may also or alternatively be replaced with nonce symbols or placeholders, re-identifiable alphanumeric strings, generic monikers or the like. In some cases, such placeholder strings or characters may permit reidentification after generation of the output.

Similarly, the output may be filtered for PII, e.g., by output controls 509 of FIG. 5. As noted above, in one or more embodiments, the PII in the output may be redacted or replaced with nonce symbols or placeholders, re-identifiable alphanumeric strings, generic monikers or the like. For example, the LLM may add or retrieve PII when generating the output, and such PII may need to be removed from the output before transmission outside of the computing environment in which the LLM is hosted or at other exit points from the LLM environment. However, the output controls 509 may also or alternatively add PII identifiable from strings added to the prompt for de-identification, again as discussed in more detail above.

The output includes one or more datums responsive to the query of the prompt. For example, where the prompt seeks a tally of transactions conducted by an entity identified at least partially by name in the prompt within a given geographical region over a given time range, possibly together with additional analyses and/or graphical representations or the like, the output may include the requested information.

Referring to step 702, the output may be evaluated against an objective function to determine a difference between the output and an open banking objective. In one or more embodiments, the objective function comprises or is executed by a complexity platform (e.g., platform 512 of FIG. 5, hosted on the service device 16 of FIG. 1 in a local environment).

The complexity platform may generally include prompt engineering heuristics and non-linear, recursive, and super literal genetic algorithms. One of ordinary skill will appreciate, however, that other decisioning and objective function evaluation algorithms and techniques are within the scope of the present invention.

The objective function of the complexity platform may be configured to evaluate the output against one or more system objectives relating to the open service being provided and the type(s) of output being sought by the prompts. For example, where the conversation is in a marketplace in a vernacular of transactions and the entities performing exchange, the prompts may seek entity identification, standardization, and related information about the entity. In turn, the corresponding system objectives might include accuracy of entity identification, efficiency of processing, accuracy of firmographic and/or location identification, or the like.

The objective function may be configured to arithmetically, logically and/or otherwise evaluate the output to determine a quality or performance of the output in view of the system objectives. In the example discussed here, the differences determined from such evaluations might be numerical (e.g., a distance function providing a value representing a difference between the output and the correct datum that was being sought) and/or logical (e.g., binary “yes” or “no” values indicating whether the sought-after information was included in the form desired in the output).

As may be appreciated from this discussion, the objective function of the complexity platform may evaluate the output across a plurality of system objectives and/or performance characteristics and may produce a plurality of differences (i.e., difference values) between the output and those open banking system objectives. For example, three (3) difference or performance characteristic values may be generated by the objective function for the output: a first indicating logically whether an entity name was identified from the prompt, a second indicating a distance between the identified entity name and a standardized entity name, and a third indicating what percentage of important firmographic details were properly identified. Other values may describe aspects of the prompt (e.g., what kinds of abbreviations were seen, what kinds of syntaxes and/or structural aspects were observed, etc.) and/or of the state of the LLM (e.g., how has it been trained previously, what is its recent success rate for such functions, etc.), which may additionally be considered performance characteristics for matching operations discussed elsewhere herein.

It should also be noted that the system objectives and objective function may retrieve, and/or may be revised in view of, external data such as external objective data (FIG. 6) or world data 516 (FIG. 5). For example, the standardized entity name information and/or important firmographic details discussed in the example above may be retrieved and the system or business objectives and/or objective function may be revised/updated, or may evaluate the output, in view of such external data. In one or more embodiments, the business objective relating to firmographic detail retrieval may be revised to reflect changes in priority among the details, and the details sought may themselves be revised.

Referring to step 703, a predefined training action and predefined prompt modification may be automatically identified based on the difference. In one or more embodiments, the automatic identification is carried out by the complexity platform (e.g., platform 512 of FIG. 5, hosted on the service device 16 of FIG. 1 in a local environment).

For example, the difference may be expressed in one or more numerical and/or logical values, as discussed in more detail above. The complexity platform may be configured to compare those values against metadata or other matching/indexing information stored respectively with the predefined training action and prompt modification. In one or more embodiments, a plurality of predefined training actions and a plurality of predefined prompt modifications are stored and managed by the complexity platform, for example in libraries. The complexity platform may be configured to generate the difference and the values, and to match the values against the metadata for one out of the plurality of predefined training actions, and one out of the plurality of predefined prompt modifications.

The matching of the values against the metadata stored for the predefined training actions and prompt modifications may proceed according to a variety of embodiments. For example, the metadata for a given one of the predefined training actions or prompt modifications may define a value or range of values for matching against the generated value across a plurality of differences or system/business objectives. It should be noted here that each system/business objective for which a difference value is generated may be referred to as a “performance characteristic” respectively for either the training action or the prompt modification.

In one or more embodiments, a generated difference value may be matched to the metadata for a training action or prompt modification for one performance characteristic, but not for one or more others represented in the metadata. Similarly, a match may be found, but the generated difference value may be at an extreme of a range or spectrum of values defined in the metadata. In each case, the unmatched performance characteristic(s) and/or presence at the edge of a matching range may reduce the ideality of selecting the corresponding training action or prompt modification.

Accordingly, matching may include calculation of a matching score by the complexity platform, e.g., representing a sum of how many generated difference values matched their corresponding performance characteristic metadata, and/or how ideal of a match was found for each performance characteristic metadata. One of ordinary skill will appreciate that such a such a score may be generated from a weighted summation and/or other algorithms and/or logic—for example, where a decision tree and/or other logic is implemented for the matching—within the scope of the present invention.

It should also be noted that the matching metadata stored with each of the libraries containing predefined training actions and prompt modifications may respectively embody or represent factors in addition to more direct performance characteristics for the training actions and prompt modifications. For example, the metadata for a predefined training action may be configured for matching against values for aspects or characteristics of the prompt, of previously-implemented prompt modifications, of features or aspects of the LLM presently and/or relating to its prior training, and/or other factors not directly related to training performance characteristics. Likewise, the metadata for a predefined prompt modification may be configured for matching against values for aspects or characteristics of the most recent training action, of additional previously-implemented training actions, of features or aspects of the LLM presently and/or in previous iterations, and/or other factors not directly related to prompt performance characteristics.

One of ordinary skill will appreciate, therefore, that matching and selection of a predefined training action or prompt modification may include consideration of a plurality of generated difference values for performance characteristics of both training actions and prompt modifications, as well as past or present aspects or features of the LLM. Moreover, the matching and selection may include consideration of one or more of a classification, a count or a frequency of a plurality of previous prompts. For example, if a majority of previous prompts sought a particular datum, and did so often, this may be taken into account by the complexity algorithm and configured into the matching metadata.

Further, either or both of a predefined training action and prompt modification may be implemented less frequently than in response to each output of the LLM. For example, a batch of outputs—e.g., taken at regular time intervals or based on a threshold number of outputs generated—may be collected and analyzed or evaluated together to select the predefined training action and/or prompt modification.

It is also foreseen that predefined training actions and prompt modifications may be implemented with different frequency—for example, where prompt modifications are selected and implemented more regularly than training actions—within the scope of the present invention. The complexity platform may be configured to schedule and modify the frequency of predefined training actions and prompt modifications in isolation and/or relative to each other based on one or more of values generated by the objective function (e.g., distances from the corresponding system objective(s)), and/or the patterns and correlations it learns between implementation of training actions and prompt modifications and LLM performance.

In one or more embodiments, therefore, the generated difference values across training and/or prompt performance characteristics may represent averages across and/or patterns detected from evaluation of a plurality of outputs.

Referring to step 704, a training data set may be curated based on the matched predefined training action and used to fine-tune and retrain the LLM. In one or more embodiments, the curation of training data 507 and fine-tuning via trained language 505 is carried out by the complexity platform 512 of FIG. 5, hosted on the service device 16 of FIG. 1 in a local environment, acting on and in communication with the LLM 504.

The predefined training action may comprise a training record definition. As noted above, the training record definition may be automatically generated by the complexity platform based on observed patterns and correlations between previous fine-tuning on the one hand and performance of one or more LLMs along the performance characteristics and/or aspects of previous prompts and/or of the present LLM status on the other hand.

The training record definition includes a description of one or more types or categories of data such as open banking records and enables automated curation of the training data set. More particularly, the definition may describe one or more record types, such as open banking data, financial institution (FI) data regarding data subjects and/or FI terms and rate limits, account records, transaction and credit card data, firmographic entity data, location data, value data, regulatory data, personally identifiable information (PII), entity identification and/or authentication data, and/or other financial and related data. The definition may, for each identified data record type, specify whether the data should be labeled, unlabeled, or the like, in each case in conformity with the training to be undertaken (e.g., self-supervised, supervised and/or reinforcement learning), which may also be identified in the definition. The definition may include timestamp or record data ranges and/or limitations, other filters or limitations on records to be used for training, retraining scheduling, model production and replacement schedules, and other details for data preparation for and implementation of fine-tuning and implementation of the fine-tuned LLM.

For example, a predefined training action may be matched for its expected efficacy in improving standardized entity identification for prompts including open banking memo fields exhibiting certain abbreviation patterns associated with entity identifiers. The predefined training action may accordingly include a definition that instructs: collection of a batch labeled open banking memo fields of corresponding financial transactions occurring with a threshold recency; filtering of the collected open banking memo fields according to the certain abbreviation patterns (i.e., to include only those fields within a certain distance of or with sufficient similarity to the certain abbreviation pattern(s)); construction of trained language from the collected and filtered labeled memo fields for consumption by the LLM (i.e., encoding the memo fields to tokenize them for consumption by the LLM); and/or scheduling fine-tuning or retraining operations and coordinating replacement of the current production LLM with the retrained and fine-tuned LLM following training.

It should be appreciated, as discussed in more detail below, that curation of the training data set is dependent on the particular conversation within the open banking services in which the LLM is being trained to participate.

In one or more embodiments, the training data set is generated from a draft training data set by automatically analyzing (e.g., using the language training controls 506) the draft training data set for PII and redacting or anonymizing the PII.

Referring to step 705, a second prompt may be generated from the matched predefined prompt modification. In one or more embodiments, the second prompt is an input data source 501 generated by the complexity platform 512 of FIG. 5, hosted on the service device 16 of FIG. 1 in a local environment. In one or more embodiments, the second prompt includes open banking data.

The matched predefined prompt modification may be defined relative to the structure, syntax, contents and/or format of one or more previous prompts. In one or more embodiments, the prompt modification is defined relative to the first or preceding prompt, or, more particularly, relative to the instruction set or template used by the complexity platform to generate the first prompt. For example, the prompt generation template for the first prompt may be structured to incorporate a user query (e.g., a data recipient or data subject query to the open banking services) and to modify same according to the prompt generation template in terms of format and to include other prompting data and information. In one or more embodiments, the prompt generation template may define contextual data such as examples that relate to and share characteristics with the query at issue and that help the LLM to activate the appropriate relationships embodied thereby to produce an accurate output.

The matched predefined prompt modification may therefore instruct changes relative to the previous prompt or a previous prompt generation template, or may simply replace any such prior template, within the scope of the present invention. For example, the matched predefined prompt modification may automatically change a previous prompt generation template or replace it with a new one such that prompts generated based on the revised/replacement version: include more or fewer multi-shot learning examples of one or more types; include broader or narrower types of open banking data; add or reduce an amount and/or change the type of contextual data relating specifically to the query at issue for processing by the LLM; change the phraseology of the query at issue and/or the ordering of the query relative to contextual and/or examples within the prompt; and/or otherwise adjust prompt engineering, prompt architecture, and/or a learning paradigm (e.g., single- or multi-shot learning).

It should also be noted that the second prompt, generated based on the changes introduced by the predefined prompt modification, may also be filtered through the one or more input controls (e.g., input controls 502 of FIG. 5), for example in the manner discussed in preceding sections, for identification and redaction or anonymization of personally identifiable information (PII). As noted above, the PII may also or alternatively be replaced with nonce symbols or placeholders, re-identifiable alphanumeric strings, generic monikers or the like. In some cases, such placeholder strings or characters may permit reidentification after generation of the output.

Referring to step 706, a second output from the fine-tuned LLM may be generated in response to the second prompt. In one or more embodiments, the generation of the second output follows the processes described above in connection with submission of the first prompt and generation of the first output. Moreover, and referring to step 707, the second output may be evaluated with the objective function to determine a difference between the second output and the open banking objective. Again, the evaluation and generation of one or more difference values may follow the processes described above, including in connection with evaluating the first prompt.

The difference values generated from the second output are likewise utilized to further iterate the fine-tuned LLM toward better achievement of the system objective(s). For example, as described above, the second difference values may be used, alone or together with additional difference values from additional outputs of the fine-tuned LLM (e.g., in batch analyses), to match against metadata of predefined libraries of training actions and prompt modifications and identify a next predefined training action and/or a next predefined prompt modification for implementation with a next iteration of the fine-tuned LLM.

In a more particular example, the second difference values (that is, differences between the second output and the open banking objective) may be used to automatically identify a second predefined training action and a second predefined prompt modification, again in much the same manner discussed above in connection with the first difference values. Further, based on the second predefined training action, a second training data set may be curated and used to retrain the retrained LLM to generate a second retrained LLM. Further, based on the second predefined prompt modification, a third prompt may be generated (e.g., including third open banking data) and used to generate a third output based on the third prompt to the second retrained LLM. The third output may, in turn, be evaluated with the objective function to determine a difference between the third output and the open banking objective, and so on and so forth.

It should also be noted that the complexity platform is preferably configured not only to identify next predefined prompt modification(s) and/or next predefined training action(s), but also to automatically learn patterns and correlations between performance of the fine-tuned LLM and implementation of the predefined training action and prompt modification at steps 704, 705. The complexity platform may use the learned patterns and correlations iteratively to automatically add to and/or revise the predefined libraries of training actions and prompt modifications.

For example, where the complexity platform identifies an improvement from the predefined training action despite a relative mismatch with one training performance characteristic, the complexity platform may reduce the weighted importance of that training performance characteristic within the metadata. For another example, where the complexity platform identifies a small improvement or worsening of performance following fine-tuning according to the predefined training action, the complexity platform may automatically add another training performance characteristic to increase the dimensionality of the matching model portion of its logic and capture an additional variable that might improve matching.

One of ordinary skill will appreciate that the complexity platform may incorporate a wide variety of automated processes for testing and expanding matching capabilities, and preferably includes a genetic algorithm and/or other evolutionary algorithm which inherently includes aspects of seemingly haphazard or random dynamic advancement toward system goals. Accordingly, a genetic algorithm component of the complexity platform may intelligently or semi-randomly introduce small or even moderate variations in one or more predefined training actions and/or prompt modifications in an effort to enhance learning about and otherwise advance the LLM toward better achievement of the system objectives.

It is also foreseen that other machine learning methods may be used to support learning by the complexity platform, including to support revision of the libraries of predefined training actions and prompt modifications and/or evolving the objective function in view of external data. The machine learning program(s) of the complexity platform may therefore recognize or determine correlations between performance and quality of outputs on the one hand, and implementation of predefined training actions and prompt modifications (and possibly other factors impacting performance discussed elsewhere herein) on the other hand.

The machine learning techniques or programs may include curve fitting, regression model builders, convolutional or deep learning neural networks, combined deep learning, pattern recognition, or the like. Based upon this data analysis, the machine learning program(s) may learn method(s) for constructing improved predefined training actions and/or prompt modifications, improved matching metadata, and/or for revising and evolving objective function(s) and objectives, for use in dynamically evolving LLM performance within a variety of conversations unique to open banking.

It should be noted that, in supervised machine learning, the complexity platform may be provided with example inputs (i.e., prior LLMs, training actions, prompt templates and/or modifications and the like) and their associated outputs (i.e., outputs from the LLM within the conversation at issue), and may seek to discover a general rule that maps inputs to outputs for improved construction of predefined training actions and prompt modifications and/or revised matching metadata and/or objective functions. In unsupervised machine learning, the complexity platform may be required to find its own structure in unlabeled example inputs.

The complexity platform may utilize classification algorithms such as Bayesian classifiers and decision trees, sets of pre-determined rules, and/or other algorithms.

The method may include additional, less, or alternate steps and/or device(s), including those discussed elsewhere herein, unless otherwise expressly stated and/or readily apparent to those skilled in the art from the description.

### Exemplary Computer-Implemented Method for Providing Large Language Model Dynamic Open Banking Services

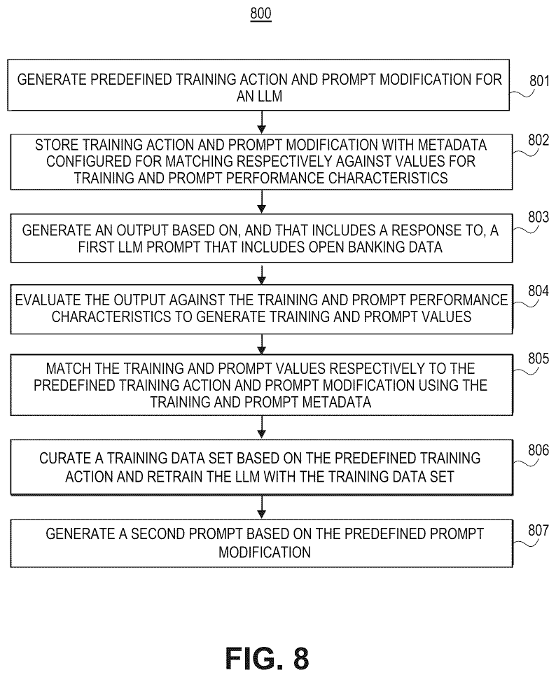

FIG. 8 depicts a flowchart including a listing of steps of another exemplary computer-implemented method 800 for providing LLM dynamic open banking services. The steps may be performed in the order shown in FIG. 8, or they may be performed in a different order. Furthermore, some steps may be performed concurrently as opposed to sequentially. In addition, some steps may be optional.

The computer-implemented method 800 is described below, for ease of reference, as being executed by exemplary devices and components introduced with the embodiments illustrated in FIGS. 1-6. For example, the steps of the computer-implemented method 800 may be performed by the client devices 12, the servers 14, the service device 16 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 801, a predefined training action and prompt modification may be generated for an LLM. In one or more embodiments, the predefined training action and prompt modification may be generated by a complexity platform 512 (FIG. 5) and/or otherwise in accordance with the discussion of method 700 above.

In one or more embodiments, the predefined training action may comprise a training record definition. The training record definition may be automatically generated by the complexity platform based on observed patterns and correlations between previous fine-tuning, prompts and/or prompt modifications and performance of one or more LLMs with respect to the performance characteristics and/or system objective(s).

The training record definition includes a description of one or more types or categories of data such as open banking records and enables automated curation of the training data set. More particularly, the definition may describe one or more record types, such as open banking data, financial institution (FI) data regarding data subjects and/or FI terms and rate limits, account records, transaction and credit card data, firmographic entity data, location data, value data, regulatory data, personally identifiable information (PII), entity identification and/or authentication data, and/or other financial and related data. The definition may, for each identified data record type, specify whether the data should be labeled, unlabeled, or the like, in each case in accordance with the training to be undertaken (e.g., self-supervised, supervised and/or reinforcement learning), which may also be specified in the definition. The definition may include timestamp or record date ranges and/or limitations, other filters or limitations on records to be used for training, retraining scheduling, model production and replacement schedules, and other details for data preparation for and implementation of fine-tuning and implementation of the fine-tuned LLM.

The training record definition may cause the complexity platform to automatically construct and transmit calls to APIs—for example, of one or more data sources, whether internal at the open banking service provider and/or external at one or more consented FIs—to collect in real-time training data fitting the parameters described in the training record definition.

Further, the predefined prompt modification may be defined relative to the structure, syntax, contents and/or format of one or more previous prompts. In one or more embodiments, the prompt modification is defined relative to a preceding prompt, or, more particularly, relative to an instruction set or template used by the complexity platform to generate the preceding prompt. For example, the prompt generation template for the preceding prompt may be structured to incorporate a user query (e.g., a data recipient or data subject query to the open banking services), to modify same according to the prompt generation template, and/or to include other prompting data and information. In one or more embodiments, the prompt generation template may define contextual data such as examples that relate to and share characteristics with the query at issue and help the LLM to activate the appropriate relationships embodied thereby to produce an accurate output.

The predefined prompt modification may therefore instruct changes relative to the previous prompt or previous prompt generation template. Also or alternatively, the prompt modification may replace any such prior template, within the scope of the present invention.

Accordingly, the predefined prompt modification may automatically change a previous prompt generation template or replace it with a new one such that prompts generated based on the revised/replacement version: include more or fewer multi-shot learning examples of one or more different types; include broader or narrower types of open banking data; add or reduce an amount and/or change the type of contextual data relating specifically to the query at issue for processing by the LLM; change the phraseology and/or language of the query at issue and/or the ordering of the query relative to contextual data and/or examples within the prompt; and/or otherwise adjust the prompt engineering, prompt architecture, and/or learning paradigm (e.g., single- or multi-shot learning) embodied by the prompt.

Like the training record definition, the predefined prompt modification may cause the complexity platform to automatically construct and transmit calls to APIs—for example, of one or more data sources, whether internal at the open banking service provider and/or external at one or more consented FIs—to collect in real-time contextual or example data fitting the parameters described in the predefined prompt modification for inclusion in one or more subsequent prompts.

The predefined training action and predefined prompt modification may be implemented uniquely within an open banking service and, more particularly, within a specific conversation having its own vernacular, relevant data types, and fine-tuned LLM.

For example, the conversation may be in a marketplace and in a vernacular of transactions and the entities performing exchange. Accordingly, the prompts submitted to the corresponding LLM may seek entity identification, standardization, and related information about the entity. The open banking service may generate the predefined training action and prompt modification to improve data intake, aggregation and analysis of data provided to the platform to identify transactional entities in unstructured data (e.g., in memo and description fields in open banking transaction data) and to associate representations and descriptions of those entities with a standardized identity. Such services of the dynamic LLM may also/alternatively include identifying geographic location(s) for entities, categorizing entities into product/service/industry types, and/or categorizing or generating explanations for financial transactions (e.g., purposes of or reasons for the transactions).

For another example, the conversation may be with consumers (i.e., data subjects) and/or financial service providers (i.e., data recipients) in the vernacular of account ownership and identity. Accordingly, the prompts submitted to the corresponding LLM may seek account ownership confirmation, identity authentication, account linking, fraud detection, and/or other conclusions. The LLM may correspondingly analyze financial data to identify individuals (e.g., data subjects) within unstructured and structured data, and verify or authenticate the individuals to a trusted or unique identity. In one or more embodiments, this includes using the dynamic LLM to sift through open banking data (e.g., unstructured or structured transaction data) and confidently associate individual identifiers and circumstantial identity information and activities associated with a request for financial services with the trusted identity and/or other known financial records, thereby generating a firm link between the requester of the financial services and the trusted identity and/or known financial records.

In turn, financial data confidently associated with a trusted identity and/or known financial records may be analyzed and used to profile an individual data subject, assess credit risk, establish account ownership (and identity), or otherwise validate or authenticate the requester and the requester's behavior(s) to enable provision of the requested financial services and/or to prevent fraud. Such activities and the request for financial services may, without limitation, include a request to open a financial account with a financial institution.

For still another example, a conversation may be in the vernacular of open banking data feeds from financial institutions (FIs), with respect to transaction aggregation. Accordingly, the prompts submitted to the corresponding LLM may seek recommendations about how best to balance open banking service objectives and data source restrictions and limitations (e.g., data volume and frequency or rate limits discussed above) to optimize the open banking services. The open banking service may improve FI data intake, aggregation and analysis by querying the dynamic LLM configured for the conversation. Where the prompt seeks recommendations on how best to aggregate open banking data to provide the open banking services, the output may embody a list of recommended parameters for aggregation operations (e.g., schedule, content, etc.) that optimize along a number of objectives such as optimization of FI rate limits, data retention costs, and partner data use requirements, as well as maximizing deduplication of records.

For yet still another example, a conversation may be in the vernacular of connection, inclusion, and value. More particularly, data subjects or recipients may assess or inquire, and prompts may be configured to seek outputs, about how best to plan/conduct financial transactions or activities in view of a broader objective measurable according to one or more metrics derived from a value store or scale. In one or more embodiments, the open banking services may include recognition and analysis of value data, enabling measurement of progress toward value objectives such as optimizing participation or investment in crypto currency ecosystems, the balance among and between triple bottom line metrics (social, environmental and economic), the balance among and between ESG metrics (environmental, social and governance), carbon credits or offsets, and the like. In such cases, the output may provide advice in the form of a transaction definition or recommendation listing parameters for the transaction which, if achieved, are likely to produce the desired optimized impact(s) on the value objectives (e.g., along a value scale) in question (such as ESG score or the like, as discussed above).

In one or more embodiments, a unique LLM is configured, maintained and modified specifically for each one (1) of the four (4) example conversations listed above (i.e., conversations respectively in the vernacular of: transactions and the entities performing exchange; account ownership and identity; open banking data feeds from financial institutions (FIs), with respect to transaction aggregation; or connection, inclusion, and value).

Accordingly, each of the four (4) separate LLMs may implement its own environment 10 and platform 500 (See FIGS. 1-6), to respectively support the four (4) separate LLMs in four (4) separate conversations. Further, predefined training action and prompt modification libraries are preferably generated, curated, indexed and/or revised separately across the four (4) conversations, at least because patterns and correlations, training languages and prompt changes and the like used to configure and populate such libraries may be optimized uniquely based on the content and nature of each such unique conversation. However, it will be appreciated that certain components of the environment 10 and/or platform 500 may be shared or consolidated for use across multiple of the conversations without departing from the spirit of the present invention.

Respectively, then, the predefined training action and predefined prompt modification may be generated and configured at step 801 to improve LLM performance in response to prompts for one of: (1) merchant entity data (such as a standardized entity name, merchant entity location, merchant entity category, and/or merchant entity firmographic data); (2) consumer identity data (such as relationships between one or more consumer identifiers and identifiers, profiles, accounts and/or identities embodied in prior financial record data, and/or one or more of an identity score evaluation, an account wallet identity evaluation, a return user experience evaluation, an account reward evaluation, or an account opening evaluation); (3) FI feed data (such as a recommendation for one or more of batching priority for transaction aggregation, account deduplication optimization, FI rate limit optimization, meeting regulatory requirements, or data retention scheduling); or (4) value optimized transaction data (such as a recommendation for one or more parameters of a putative transaction that optimize(s) one or more values on a measurable value scale).

In view of the varying objectives of respective LLM models and conversations outlined herein, it should be appreciated that predefined training actions and predefined prompt modifications generated and curated by corresponding complexity platforms will vary in their respective training record definitions and prompt template changes.

Referring to step 802, the predefined training action and predefined prompt modification may be stored with metadata configured for matching respectively against values for training and prompt performance characteristics. In one or more embodiments, the predefined training action and prompt modification metadata may be generated, configured for matching, and stored by a complexity platform 512 (FIG. 5) and/or otherwise in accordance with the discussion of method 700 above.

In accordance with method 700, the matching metadata for each of the predefined training action and predefined prompt modification may describe values or value ranges for each of a plurality of system/business objectives and/or LLM performance characteristics (e.g., training and/or prompt performance characteristics), all with reference to and/or in view of the particular conversation for which the LLM is configured.

Turning briefly to FIG. 6, libraries of predefined training actions and prompt modifications for a conversation are illustrated, with each library storing six (6) options (corresponding respectively to six (6) training action definitions and prompt template revisions/replacements). Each predefined training action and prompt modification is depicted with alphanumeric characters representing ten (10) different training and/or prompt performance characteristics. Each alphanumeric character represents metadata comprising one or more criteria for matching respectively against a value for a system/business objective (i.e., training and/or prompt performance characteristic). It is again noted that the value for each objective/characteristic may be generated by an objective function evaluating one or more outputs against the objective, and therefore may represent a distance from the optimal objective or optimal output and/or a logical value (i.e., “yes”or “no”).

For example, metadata for a first of the characteristics (“A”) may define a numerical range of matching values (e.g., 3.5-7.5) for a training performance characteristic. Metadata for a second of the characteristics (“3”) may define a matching logical value (e.g., “yes” or “no”) for a prompt performance characteristic. Metadata for a third of the characteristics (“B”) may reference one or more matching profile types for the LLM. The profile types of the third characteristic may describe one or more prior training actions, preliminary fine-tuning types, or other parameters or aspects that describe the state of the LLM at the time(s) when the output(s) were generated. The remainder of the characteristic metadata represented by the alphanumeric characters may be similarly configured across various performance characteristics by the complexity platform.

Accordingly, the metadata comprising criteria for a plurality of performance characteristics are generated by the complexity platform for storage with the corresponding predefined training actions and prompt modifications. The complexity platform automatically observes and deduces patterns and correlations between each training action or prompt modification and corresponding changes in LLM outputs (i.e., whether improvement or worsening relative to system objectives was experienced). The complexity platform automatically captures the characteristics embodied by the matching metadata for each such pattern or correlation, and uses such information to generate the matching metadata for each training action and prompt modification. The stored predefined training actions and prompt modifications may then be matched in real-time to LLM outputs, and accordingly implemented to retrain/fine-tune the LLM and changes its prompts to iterate the LLM toward better performance relative to the system objectives, as discussed in more detail above.

Referring to step 803, an output may be generated based on and that includes a response to a first LLM prompt that includes open banking data. In one or more embodiments, the output may be generated by LLM 504 (FIG. 5) and/or otherwise in accordance with the discussion of method 700 above. Accordingly, it should be appreciated that related operations—such as PII filtering/redaction by input controls 502 and/or output controls 509, and/or encoding/decoding and tokenization translation processes—may also occur within the scope of the present invention.

As discussed in more detail above, the output responsive to the first prompt will vary depending on the conversation and corresponding LLM. For example, the first prompt may be for one of: (1) merchant entity data (such as a standardized entity name, merchant entity location, merchant entity category, and/or merchant entity firmographic data); (2) consumer identity data (such as relationships between one or more consumer identifiers and identifiers, profiles, accounts and/or identities embodied in prior financial record data, and/or one or more of an identity score evaluation, an account wallet identity evaluation, a return user experience evaluation, an account reward evaluation, or an account opening evaluation); (3) FI feed data (such as a recommendation for one or more of batching priority for transaction aggregation, account deduplication optimization, FI rate limit optimization, meeting regulatory requirements, or data retention scheduling); or (4) value optimized transaction data (such as a recommendation for one or more parameters of a putative transaction that optimize(s) one or more values on a measurable value scale).

The open banking data included with the first prompt may correspond to the conversation as well. For example, the open banking data may include open banking data (e.g., memo fields of corresponding financial transactions) for both the subject of the query (i.e., the data subject or recipient itself) as well as relevant examples from third party transactions.

Where the first prompt is in a conversation with the marketplace in the vernacular of transactions and the entities performing exchange, it may seek a merchant entity datum (such as a standardized entity name) and the open banking data included in the first prompt might include a deterministic lookup table associated with a named entity recognition model.

Where the prompt is instead in a conversation with data subjects (such as consumers) and/or data recipients (such as financial institutions) in the vernacular of account ownership and identity, it may seek a consumer identity datum (such as a consumer identification) and the open banking data included in the first prompt might include fraud example fact patterns and consented financial records comprising financial institution and credit card processor account records.

Where the prompt is instead in a conversation with an open-banking provider in the vernacular of data feeds from FIs (e.g., with respect to transaction aggregation), it may seek an FI feed datum (such as a recommendation for one of the following: batching priority for transaction aggregation, account deduplication optimization, FI rate limit optimization, meeting regulatory requirements, or data retention scheduling) and the open banking data included in the first prompt might include consented financial institution account records, FI rate limit information, open service banking product use table(s), and/or open banking service product priority account lookup table(s).

Where the prompt is instead in a conversation with an overall financial network in the vernacular of connection, inclusion, and value, it may seek value optimized transaction data (such as a recommendation for one of the following: or one or more parameters of a putative transaction that optimize(s) one or more values) and the open banking data included in the first prompt might include value store data and consented financial records comprising financial institution and credit card processor account records.

In one or more embodiments, the open banking data included in the prompt may additionally include other types of data discussed above in connection with other conversations and/or illustrated in FIG. 6. It should also be appreciated that the open banking data types listed in these examples are illustrative and not exhaustive, it being understood that system objective(s) may render relevant the inclusion of unlisted data types with prompts within the scope of the present invention.

Referring to step 804, the output may be evaluated against the training and prompt performance characteristics to generate training and prompt values. In one or more embodiments, the training and prompt performance characteristics are analogous to or are system/business objectives and/or are embodied in an objective function of the respective complexity platform.

The output evaluation and value generation may be performed by the complexity platform 512 (FIG. 5) and/or otherwise in accordance with the discussion of method 700 above. Accordingly, it should be appreciated that other operations, features or data described in method 700 above, such as aspects of the complexity platform (e.g., objective function(s) and evolution thereof and/or revision thereto), may also occur or be included within the scope of the present invention. For example, the objective function of the complexity platform may evaluate the output based on, and/or be revised or evolved in view of, external objective data (e.g., 516 of FIG. 5).

In the example of FIG. 6, the output is evaluated by the objective function of the complexity platform across a plurality of performance characteristics corresponding to business/system objectives to produce a plurality of values. The values are matched against the metadata for the libraries of predefined training actions and prompt modifications. The degree and types of matching across the multiple performance characteristics may be evaluated with a weighted summation or other algorithm to select the best matching predefined training action and/or prompt modification.

It is foreseen that more or fewer values may be generated for each output than are represented in the metadata for each training action or prompt modification, and that the various sets of performance characteristics represented in the metadata across the training actions and prompt modifications may not be identical. Accordingly, dozens (or more) of performance characteristics may be represented in a library of training actions or prompt modifications, and a similar number of values may be generated by the complexity platform through evaluating the output for matching against the metadata.

Conversely, where values cannot be or were not generated from an output for a given performance characteristic represented in the metadata, the matching algorithm of the complexity platform may adjust the corresponding matching score accordingly to reflect an unknown degree of matching.

Referring to step 805, the training and prompt values may be matched to the predefined training action and predefined prompt modification using the training and prompt metadata stored therewith.

The matching may be performed by the complexity platform 512 (FIG. 5) and/or otherwise in accordance with the discussion of method 700 above. Accordingly, it should be appreciated that other operations, features or data described in method 700 above, such as determining patterns and correlations between the output values and the previous prompt modification and/or training action implemented by the platform and correspondingly revising the predefined prompt modification and/or training action libraries and/or the matching metadata thereof, may also occur or be included within the scope of the present invention.

As discussed in more detail above, the generated output values across the plurality of training and prompt performance characteristics may be matched against the metadata for the predefined training actions and prompt modifications. In one or more embodiments, the complexity platform generates matching scores (e.g., weighted scores) or other algorithmic output. The scores or similar output enable the platform to identify the matching training action(s) and/or prompt modification(s) most likely to move future outputs of the LLM closer to the system objective(s) and/or otherwise move in a preferred manner along gradients embodied by the objective function and/or aspects of the performance of the corresponding open banking service(s).

The resultant best matching predefined training action and prompt modification are identified and implemented by the complexity platform as discussed in more detail above and below. It should be noted again that the predefined training action and prompt modification are optimized for moving the LLM toward better performance with reference to a given conversation (i.e., dependent upon whether the conversation is around: (1) merchant entity data; (2) consumer identity data; (3) FI feed data; or (4) value optimized transaction data).

Referring to step 806, a training data set may be curated based on the predefined training action and used to retrain the LLM to generate a fine-tuned LLM.

The training data set curation may be performed by the complexity platform 512 (FIG. 5), including by collecting training data 507, and/or otherwise in accordance with the discussion of method 700 above. Further, the fine-tuning may be of LLM 504 (FIG. 5), using trained language 505, and/or otherwise in accordance with the discussion of method 700 above. Accordingly, it should be appreciated that related operations—such as PII filtering/redaction of a draft training data set by language training controls 506 to generate the training data set, and/or encoding/decoding and tokenization translation processes to generate trained language 505—may also occur within the scope of the present invention.

Turning briefly to FIG. 6, the training data may be collected from a variety of data sources and may include FI data, transaction data, firmographic entity data, location data, value data and/or other data types.

The predefined training action may comprise a training record definition. As noted above, the training record definition may be automatically generated by the complexity platform based on observed patterns and correlations between previous fine-tuning and performance of one or more LLMs along the performance characteristics.

The training record definition includes a description of one or more types or categories of data such as open banking records and enables automated curation of the training data set. More particularly, the definition may describe one or more record types, such as open banking data, financial institution (FI) data regarding data subjects and/or FI terms and rate limits, account records, transaction and credit card data, firmographic entity data, location data, value data, regulatory data, personally identifiable information (PII), entity identification and/or authentication data, and/or other financial and related data. The definition may, for each identified data record type, specify whether the data should be labeled, unlabeled, or the like, in each case in conformity with the training to be undertaken (e.g., self-supervised, supervised and/or reinforcement learning), which may also be identified in the definition. The definition may include timestamp or record data ranges and/or limitations, other filters or limitations on records to be used for training, retraining scheduling, model production and replacement schedules, and other details for data preparation for and implementation of fine-tuning and implementation of the fine-tuned LLM.

The training record definition may be customized for use with the corresponding open banking conversation the LLM is configured to participate in.

For example, a predefined training action for an LLM in merchant entity data conversations may be matched for its expected efficacy in improving standardized entity identification for prompts including open banking memo fields exhibiting certain abbreviation patterns associated with entity identifiers. The predefined training action may accordingly include a definition that instructs: collection of a batch labeled open banking memo fields of corresponding financial transactions occurring with a threshold recency; filtering of the collected open banking memo fields according to the certain abbreviation patterns (i.e., to include only those fields within a certain distance of or with sufficient similarity to the certain abbreviation pattern(s)); construction of trained language from the collected and filtered labeled memo fields for consumption by the LLM (i.e., encoding the memo fields to tokenize them for consumption by the LLM); and/or scheduling fine-tuning or retraining operations and coordinating replacement of the current production LLM with the retrained and fine-tuned LLM following training.

The merchant entity data LLM may, for example, be fine-tuned on training data, and prompted with prompts, that respectively include a deterministic lookup table associated with a named entity recognition model, to produce a retrained merchant entity LLM.

For another example, the consumer identity data LLM may be fine-tuned on training data, and prompted with prompts, that respectively include fraud example fact patterns and consented financial records comprising financial institution and credit card processor account records, to produce a retrained consumer identity data LLM.

For yet another example, the FI feed data LLM may be fine-tuned on training data, and prompted with prompts, that respectively include one or more of consented financial institution account records, FI rate limit information, open service banking product use table(s), or open banking service product priority account lookup table(s), to produce a retrained FI feed data LLM.

For still yet another example, the value optimized transaction data LLM may be fine-tuned on training data, and prompted with prompts, that respectively include value store data and consented financial records comprising financial institution and credit card processor account records, to produce a retrained value optimized transaction data LLM.

One of ordinary skill will appreciate that the training record definition(s) for consumer identity, FI feed and value optimized transaction LLMs may also include other training data parameters, such as those listed above in connection with the merchant entity LLM example, within the scope of the present invention.

Referring to step 807, a second prompt may be generated based on the predefined prompt modification.

The second prompt may be generated by the complexity platform 512 (FIG. 5) and/or otherwise in accordance with the discussion of method 700 above. Accordingly, it should be appreciated that related operations—such as submission of the second prompt to the LLM, PII filtering/redaction by input controls 502 and/or output controls 509, and/or encoding/decoding and tokenization translation processes—may also occur within the scope of the present invention.

The second prompt, generated based on the predefined prompt modification, preferably is configured and recognized by the complexity platform as being more likely than the first prompt to generate an optimum output from the LLM according to the system/business objectives.

Accordingly, embodiments of the present invention enable iterative progression toward system/business objectives. In the example flow of FIG. 6, four (4) prompts and four (4) corresponding outputs are illustrated. In one or more embodiments, these prompts and outputs are staggered in time, and one or more predefined training actions fine-tune the corresponding LLM based on one of the prompt/output sets, and the fine-tuned LLM performs better with another of the prompt output sets, and so on and so forth.

Preferably, the automated complexity platform and its objective function are configured to automatically identify patterns and correlations between aspects of the LLM and its configuration and training, and/or of prompts and prompt modifications on the one hand, and output and output performance characteristics relative to system objectives on the other hand, to automatically improve construction of predefined training actions and prompt modifications and generation and storage of matching metadata stored therewith. For example, in one or more embodiments: the training metadata are automatically configured for matching against the training value by the complexity platform by determining LLM training performance correlations between previous training values and previous training data sets for the LLM; and the prompt metadata are automatically configured for matching against the prompt value by the complexity platform by determining LLM prompt performance correlations between previous prompt values and previous prompt modifications for the LLM.

Moreover, in one or more embodiments, the complexity platform may automatically generate and/or revise the system objectives or objective functions—including by automatically generating metrics from external data value stores or the like for use in the objective functions (e.g., to capture and measure values such as ESG scores or the like)—and otherwise field feedback and data from the external world to keep the LLMs described or taught herein in alignment with the open banking services provided therewith. For example, a predefined training performance characteristic and predefined prompt performance characteristic may be embodied in an objective function, and the complexity platform may be configured to automatically: retrieve external objective data; analyze the external objective data to determine an updated business objective; and based on the updated business objective, generate a revised objective function including respectively a revised predefined prompt performance and a revised predefined training performance characteristic.

It should be reiterated that a central goal of embodiments of the present invention is to provide a technological mechanism for improved system performance of open banking services. Namely, embodiments of the present invention automatically take steps to shore up perceived weakness(es) in system performance.

While the LLMs trained according to embodiments of the present invention to participate in disparate discussions relating to open banking services, it is foreseen that isolation of those LLMs and conversations need not be complete. For example, as discussed above, components of the system and/or platform may be shared across LLMs and/or conversations, and the complexity platform(s) may be configured to share pattern and correlation learning across the various open banking services and use cases.

Thus, such disparate use cases and conversations may nonetheless be developed, implemented and iterated/improved within a common open banking service and in parallel. That is, the corresponding LLMs may be implemented and fine-tuned independently, yet may be utilized according to common technologies and with shared learning whereby a discovery of a successful improvement pattern in one conversation may automatically recommend itself for trial or implementation in a different conversation. The unique metadata construction and matching processes described herein may advantageously enable such cross-learning across the different LLMs and conversations.

Further, in one or more embodiments, the complexity platform comprises a non-linear, recursive, super literal, genetic algorithm that moves recursively through vernacular selection and language selection with both feedback and feedforward filters. The platform finds local maxima and minima of each feature or constraint (e.g., of the system objectives of the objective function) and evaluates outputs against that selection landscape for efficacy, thereby learning from its own survival or perishing.

The method may include additional, less, or alternate steps and/or device(s), including those discussed elsewhere herein, unless otherwise expressly stated and/or readily apparent to those skilled in the art from the description.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof) , registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. Non-transitory computer-readable storage media having computer-executable instructions stored thereon for providing dynamic large language model (LLM) open banking services, wherein when executed by at least one processor the computer-executable instructions cause the at least one processor to:
generate a predefined training action and a predefined prompt modification for consumer identity data prompts;
store the predefined training action in association with training metadata, the training metadata being configured for matching against one or more values for a predefined training performance characteristic of an LLM;
store the predefined prompt modification in association with prompt metadata, the prompt metadata being configured for matching against one or more values for a predefined prompt performance characteristic of the LLM;
generate an output based on a first prompt to the LLM, the first prompt including open banking data and seeking consumer identity data, and the output including a response from the LLM relating to the consumer identity data;
evaluate the output against the predefined training performance characteristic to generate a training value;
evaluate the output against the predefined prompt performance characteristic to generate a prompt value;
match the training value to the predefined training action using the training metadata;
match the prompt value to the predefined prompt modification using the prompt metadata;
based on the predefined training action, curate a training data set and retrain the LLM on the training data set to generate a retrained LLM for consumer identity data prompts;
based on the predefined prompt modification, generate a second prompt, the second prompt including second open banking data and seeking one or both of the consumer identity data and second consumer identity data; and
generate a second output based on the second prompt to the retrained LLM.

2. The non-transitory computer-readable storage media of claim 1, wherein at least one of: (a) the matching to the predefined training action is based in part on the prompt value; or (b) the matching to the predefined prompt modification is based in part on the training value.

3. The non-transitory computer-readable storage media of claim 1, wherein at least one of: (a) the matching to the predefined training action is based in part on one or more additional prompt values corresponding to additional predefined training performance characteristics of the LLM; or (b) the matching to the predefined prompt modification is based in part on one or more additional training values corresponding to additional predefined prompt performance characteristics of the LLM.

4. The non-transitory computer-readable storage media of claim 1, wherein—
the consumer identity data and the second consumer identity data each respectively relates one or more consumer identifications included respectively in the first and second prompts to prior financial record data,
each of the training data set, the open banking data, and the second open banking data respectively include fraud example fact patterns and consented financial records comprising financial institution and credit card processor account records.

5. The non-transitory computer-readable storage media of claim 4, wherein each of the consumer identity data and the second consumer identity data respectively includes one or more of: an identity score evaluation, an account wallet identity evaluation, a return user experience evaluation, an account reward evaluation, or an account opening evaluation.

6. The non-transitory computer-readable storage media of claim 1, wherein the predefined training action includes a training record definition, the training record definition comprising a description of one or more types of open banking records for automatically performing the curation of the training data set.

7. The non-transitory computer-readable storage media of claim 1, wherein the predefined prompt modification includes at least one of the following for automatically performing the generation of the second prompt: a prompt engineering modification, a prompt architecture modification, or a multi-shot learning modification.

8. The non-transitory computer-readable storage media of claim 1, wherein the computer-executable instructions further cause the at least one processor to—
automatically analyze a draft first prompt and a draft second prompt to identify personally identifiable information (PII),
automatically generate the first prompt by redacting or anonymizing the corresponding PII in the draft first prompt,
automatically generate the second prompt by redacting or anonymizing the corresponding PII in the draft second prompt.

9. The non-transitory computer-readable storage media of claim 8, wherein the computer-executable instructions further cause the at least one processor to—
automatically analyze a draft training data set to identify personally identifiable information (PII),
automatically generate the training data set by redacting or anonymizing the PII in the draft training data set.

10. The non-transitory computer-readable storage media of claim 1, wherein—
the training metadata and the prompt metadata are configured respectively for the matching operations by a complexity platform that includes one or more prompt engineering heuristics and one or more non-linear, recursive, or super literal genetic algorithms,
the training metadata are automatically configured for matching against the training value by the complexity platform by determining LLM training performance correlations between previous training values and previous training data sets for the LLM,
the prompt metadata are automatically configured for matching against the prompt value by the complexity platform by determining LLM prompt performance correlations between previous prompt values and previous prompt modifications for the LLM.

11. A computer-implemented method for providing dynamic large language model (LLM) open banking services, comprising, via one or more transceivers and/or processors:
generating a predefined training action and a predefined prompt modification for consumer identity data prompts;
storing the predefined training action in association with training metadata, the training metadata being configured for matching against one or more values for a predefined training performance characteristic of an LLM;
storing the predefined prompt modification in association with prompt metadata, the prompt metadata being configured for matching against one or more values for a predefined prompt performance characteristic of the LLM;
generating an output based on a first prompt to the LLM, the first prompt including open banking data and seeking consumer identity data, and the output including a response from the LLM relating to the consumer identity data;
evaluating the output against the predefined training performance characteristic to generate a training value;
evaluating the output against the predefined prompt performance characteristic to generate a prompt value;
matching the training value to the predefined training action using the training metadata;
matching the prompt value to the predefined prompt modification using the prompt metadata;
based on the predefined training action, curating a training data set and retraining the LLM on the training data set to generate a retrained LLM for consumer identity data prompts;
based on the predefined prompt modification, generating a second prompt, the second prompt including second open banking data and seeking one or both of the consumer identity data and second consumer identity data; and
generating a second output based on the second prompt to the retrained LLM.

12. The computer-implemented method of claim 11, wherein at least one of: (a) the matching to the predefined training action is based in part on the prompt value; or (b) the matching to the predefined prompt modification is based in part on the training value.

13. The computer-implemented method of claim 11, wherein at least one of: (a) the matching to the predefined training action is based in part on one or more additional prompt values corresponding to additional predefined training performance characteristics of the LLM; or (b) the matching to the predefined prompt modification is based in part on one or more additional training values corresponding to additional predefined prompt performance characteristics of the LLM.

14. The computer-implemented method of claim 11, wherein—
the consumer identity data and the second consumer identity data each respectively relates one or more consumer identifications included respectively in the first and second prompts to prior financial record data,
each of the training data set, the open banking data, and the second open banking data respectively include fraud example fact patterns and consented financial records comprising financial institution and credit card processor account records.

15. The computer-implemented method of claim 14, wherein each of the consumer identity data and the second consumer identity data respectively includes one or more of: an identity score evaluation, an account wallet identity evaluation, a return user experience evaluation, an account reward evaluation, or an account opening evaluation.

16. The computer-implemented method of claim 11, wherein the predefined training action includes a training record definition, the training record definition comprising a description of one or more types of open banking records for automatically performing the curation of the training data set.

17. The computer-implemented method of claim 11, wherein the predefined prompt modification includes at least one of the following for automatically performing the generation of the second prompt: a prompt engineering modification, a prompt architecture modification, or a multi-shot learning modification.

18. The computer-implemented method of claim 11, further comprising, via the one or more transceivers and/or processors—
automatically analyzing a draft first prompt and a draft second prompt to identify personally identifiable information (PII),
automatically generating the first prompt by redacting or anonymizing the corresponding PII in the draft first prompt,
automatically generating the second prompt by redacting or anonymizing the corresponding PII in the draft second prompt.

19. The computer-implemented method of claim 18, further comprising, via the one or more transceivers and/or processors—
automatically analyzing a draft training data set to identify personally identifiable information (PII),
automatically generating the training data set by redacting or anonymizing the PII in the draft training data set.

20. The computer-implemented method of claim 11, wherein—
the training metadata and the prompt metadata are configured respectively for the matching operations by a complexity platform that includes one or more prompt engineering heuristics and one or more non-linear, recursive, or super literal genetic algorithms,
the training metadata are automatically configured for matching against the training value by the complexity platform by determining LLM training performance correlations between previous training values and previous training data sets for the LLM,
the prompt metadata are automatically configured for matching against the prompt value by the complexity platform by determining LLM prompt performance correlations between previous prompt values and previous prompt modifications for the LLM.
